(19) United States
(12) Patent Application Publication
(10) Pub. No.: US 2008/0267021 A1
(43) Pub. Date: Oct. 30, 2008

(54) Recording method, optical disk, reproduction method, and recording/reproduction device

(75) Inventors: Tomo Kishigami, Tokyo (JP); Nobuo Takeshita, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 11/797,056

(22) Filed: Apr. 30, 2007

(51) Int. Cl. G11B 7/00

(52) U.S. Cl. 369/44.23

(57) ABSTRACT

A wide test region is ensured in an optical disk and the number of repeated recording instances is suppressed so that the optical disk is made insusceptible to damage and the test region can effectively be utilized. In an optical disk which includes a plurality of recording layers each having a power adjustment region for performing adjustment of power of a beam emitted while the data is recorded and in which the data can be rewritten in each recording layer, when, in performing the adjustment of power while the data is recorded, a region between a first power adjustment region that is a power adjustment region in a first recording layer and a second power adjustment region that is a power adjustment region in a second recording layer provided at a position that is more apart than that of the first recording layer from a plane from which the light beam enters becomes smaller, along a radial direction of the optical disk, than a predetermined size, a utilized region, in one of the first power adjustment region and the second power adjustment region, which is larger than that in the other is erased.

### TECHNICAL FIELD

The present invention relates to an optical disk having a plurality of recording layers. In particular, the present invention relates to an optical disk including a test-recording region, in each of the recording layers, for setting an optimal recording power, in recording data in each of the recording layers. Moreover, the present invention relates to a recording device (recording method) for recording data in the foregoing optical disk. Still moreover, the present invention relates to a reproduction device (reproduction method) for reproducing data that has been recorded in the foregoing optical disk.

### BACKGROUND OF THE INVENTION

In an optical disk in which data can be recorded, a test-recording region is provided so as to set an optimal recording condition. With an optical disk having a plurality of recording layers, in the case where data is recorded in a layer that is situated inner with respect to a layer into which a recording light beam enters, the optimal recording condition for the inner layer depends on whether or not data has been recorded in the outer layer. For that purpose, it is requires to comprehend the state of recording in the outer layer. In addition, in the case where data is recorded in the inner layer, it is required to take into consideration the diameter of a light beam that passes through the outer layer and the amount of relative positional deviation between the inner layer and the outer layer so as to avoid the effect of the state of recording in the outer layer.

As measures for the foregoing matters, provision is made for an optical disk (Refer to, for example, Patent Document 1.) in which a test region is disposed so that, in the case where data is recorded in an inner layer, by taking into consideration the radius of a light beam that passes through an outer layer and the amount of relative positional deviation between the inner layer and the outer layer, the power of a recording light beam is adjusted.

Patent Document 1: WO Publication No. 2002-023542 (p. 1 to p. 34, FIGS. 1 to 14).

### SUMMARY OF THE INVENTION

In the case where, with an optical disk having a plurality of recording layers, test recording is performed in an inner layer, it is required to homogenize the state of recording in an outer layer. In the case where respective test-recording regions in the recording layers are arranged in such a way as not to overlap one another, the regions, in the optical disk, where the test-recording regions can be provided are limited; therefore, the test-recording region is diminished. In the case of a rewritable optical disk, when the test recording is repeated in the small region, the number of recurrent recording instances increases, whereby the optical disk is deteriorated and becomes susceptible to damage.

The present invention has been implemented in order to solve the foregoing problems; the objective of the present invention is to ensure a wide test-recording region in an optical disk. Moreover, the objective of the present invention is to suppress the number of recurrent test recording instances that are performed in the test-recording region. Still moreover, the objective of the present invention is to make the optical disk insusceptible to damage and to enable the test-recording region to be utilized effectively.

The present invention provides a recording method for recording data in an optical disk which includes a plurality of recording layers each having a power adjustment region for performing adjustment of power of a beam emitted while the data is recorded and in which the data can be rewritten in each recording layer; when, along a radial direction of the optical disk, a region between a first power adjustment region that is a power adjustment region in a first recording layer and a second power adjustment region that is a power adjustment region in a second recording layer provided at a position that is more apart than that of the first recording layer from a plane from which the light beam enters becomes smaller than a predetermined size, erasing processing is performed in which the utilized region, out of two utilized regions in the first and second power adjustment regions, which is larger is erased.

According to the present invention, a wide test-recording region is ensured in an optical disk. Moreover, the number of recurrent test recording performed in the test-recording region can be suppressed. Still moreover, the optical disk is made insusceptible to damage. Furthermore, the test-recording region can be utilized effectively.

### BRIEF DESCRIPTION OF THE DRAWINGS

FIG. 1 is a diagram illustrating an optical disk according to Embodiment 1;

FIG. 2 is a diagram illustrating a recording device according to Embodiment 1;

FIG. 3 is a diagram illustrating the relationship between a light beam and recording layers of an optical disk according to Embodiment 1;

FIG. 4 is a set of diagrams illustrating the positional deviation between a first layer and a second layer in Embodiment 1;

FIG. 5 is a set of diagrams illustrating how to utilize power adjustment regions in an optical disk according to Embodiment 1;

FIG. 6 is a set of diagrams illustrating how to utilize power adjustment regions in an optical disk according to Embodiment 2;

FIG. 7 is a flowchart for explaining power adjustment in a recording device according to Embodiment 3; and

FIG. 8 is a set of diagrams illustrating how to utilize power adjustment regions in an optical disk according to Embodiment 4.

### DESCRIPTION OF SYMBOLS

100: optical disk,
101: light beam,
102: first recording film,
103: second recording film,
110: inner-periphery power adjustment region (PI),
111: recording management region (R),
112: compatibility region (L),
113: data recording region,
114: compatibility region (O),
115: outer-periphery power adjustment region (PO),
120: objective lens of optical pickup,
200: recording device,
202: formatter,
203: pulse-strategy creation circuit,
204: drive circuit,
205: optical head,
207: Pre-Amp circuit,
208: servo circuit,
209: power-adjustment computing circuit,
210: buffer memory.

### BEST MODE FOR CARRYING OUT THE INVENTION

### Embodiment 1

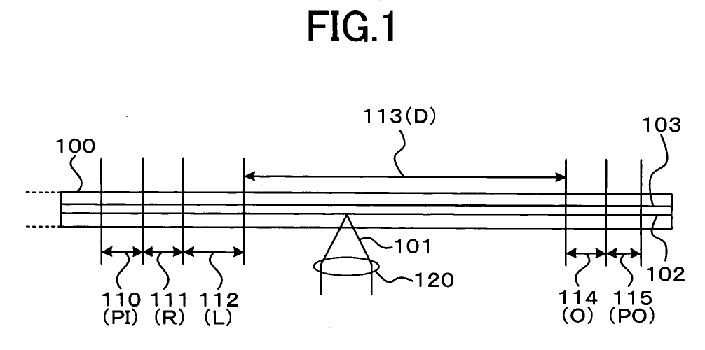

FIG. 1 is a diagram illustrating an optical disk according to an embodiment of the present invention. This cross section diagram shows the half area of the optical disk. The optical disk has two recording layers. Additionally, the optical disk is a rewritable phase-change optical disk. In FIG. 1, Reference Numeral 100 denotes an optical disk. Reference Numeral 102 denotes a first recording layer. Reference Numeral 103 denotes a second recording layer. Reference Numerals 110 and 115 denote power adjustment regions (hereinafter, referred to also as test regions) for optimally adjusting the power of laser light (a laser beam) in the case where data is recorded in the optical disk 100. Reference Numeral 110 is a power adjustment region (PI) situated at the inner periphery of the optical disk 100. Reference Numeral 115 is a power adjustment region (PO) situated at the outer periphery of the optical disk 100. Reference Numeral 111 denotes a recording management region (R) in which management information and control information on recording are recorded. Reference Numerals 112 and 114 denote compatibility regions L and O, respectively, in which information (e.g., information for controlling the servo system in a reproduction device or the like, and hereinafter, referred to also as reproduction control information) for making the optical disk 100 compatible with a reproduction-only disk is recorded. In addition, by recording the reproduction control information, the optical disk can be reproduced by a playback-only player or the like. Additionally, Reference Numeral 112 includes a disk management region in which disk management information for the optical disk 100 is recorded. A data region (D) 113 for recording data is provided between the compatibility region (L) 112 and the compatibility region (O) 114. In the data region 113, desired data is recorded by an optical disk device. In the optical disk 100, the power adjustment region (PI) 110, the recording management region 111, the compatibility region (L) 112, the data region 113, the compatibility region (O) 114, and the power adjustment region (PO) 115 are arranged in that order, from the inner periphery to the outer periphery. Reference Numeral 120 denotes an objective lens of an optical pickup. Reference Numeral 101 denotes a light beam (recording light beam) emitted from the objective lens 120. The light beam 101 enables recording of information in, and/or reproduction of information from, the optical disk 100.

In general, before data is recorded in the optical disk 100, the light beam power is adjusted through the test recording so as to be optimal. In addition to a region for recording data, a power adjustment region to be utilized for adjusting recording power is provided in the optical disk 100. In FIG. 1, as an example, a case, in which the power adjustment regions 110 and 115 are provided at the innermost periphery and the outermost periphery, respectively, of the optical disk 100, has been described. The adjustment of recording power is performed for each recording layer. The adjustment of recording power is carried out by use of the power adjustment regions 110 and 115 that are situated in the same layer as a particular layer in which data is recorded. In this situation, in the case where data is recorded in the second layer, the light beam 101 passes through the first layer. Accordingly, the result of the power adjustment in the case where data is recorded in the second layer depends on whether or not data has been recorded in the first layer. Thus, in the case where the power adjustment is performed in the second layer, it is required to homogenize the recording state of the corresponding first layer (hereinafter, the requirement is referred to also as a recording order). Accordingly, in Embodiment 1, in the case where the power adjustment is performed in the second layer, the recording region of the first layer (a recording layer at the light beam-incident side), whose location corresponds to the location of the power adjustment region of the second layer, is made to be in a state in which no data is recorded. In addition, the optical disk 100 is a rewritable phase-change optical disk; therefore, in the case where data has been recorded in the first layer, by being erased, the first layer can be made approximately to be in a state in which no data is recorded.

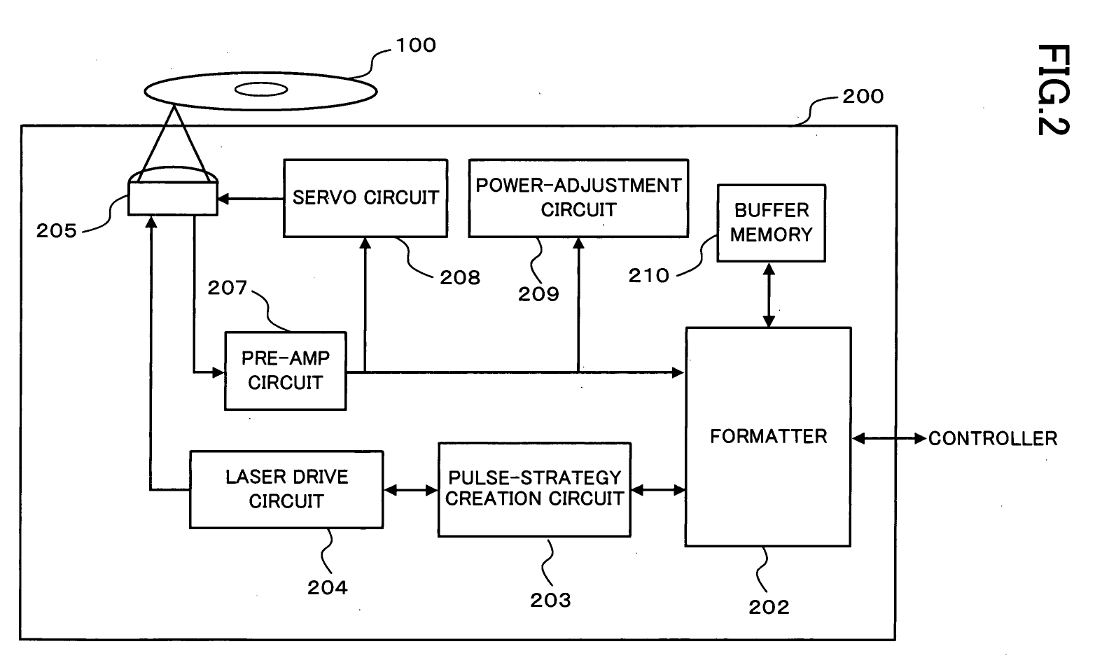

FIG. 2 is a block diagram illustrating a recording device 200 according to Embodiment 1 of the present invention. The recording device 200 is connected to a controller (unillustrated). A formatter 202, e.g., in the case of recording, stores data from the controller in a buffer memory 210 and then adds an error-correction code to the data. Additionally, in accordance with a predetermined modulation rule, the formatter 202 modulates the data to which the error-correction code has been added, thereby creating recording data. After that, the formatter 202 determines the arrangement of the recording data, in accordance with the format of the optical disk 100.

Before being recorded in the optical disk 100, the arranged recording data is modulated by a pulse-strategy creation circuit 203 lo into a pulse train so that an optimal mark is formed. The modulated recording data is inputted as a driving signal to a drive circuit 204. The drive circuit 204 drives an optical head 205, based on the driving signal. As a result, the data is recorded in the optical disk 100.

The positioning of the optical head 205 is carried out in the following way:

After being amplified by a Pre AMP circuit 207, a reproduced signal from the optical head 205 is inputted to the formatter 202. The formatter 202 decodes address information, based on the inputted reproduced signal. The address information enables the present position of the optical head 205 to be obtained. The difference value between the address information corresponding to the present position and the address information corresponding to an objective position (a travel destination) is inputted to a servo circuit 208. After that, the servo circuit 208 makes the optical head 205 travel to the objective position.

When data is recorded in the data region, test recording is preliminarily performed in the inner-periphery power adjustment region (PI) 110 or the outer-periphery power adjustment region (PO) 115. A power-adjustment computing circuit 209 reproduces the data that has been recorded on the occasion of the test recording and evaluates the obtained waveform. Additionally, the power-adjustment computing circuit 209 makes the recording power optimal, based on the result of the evaluation. In addition, the power adjustment regions PI and PO can selectively be utilized, for example, in the following way:

That is to say, in the case where the optical disk 100 is utilized at a low rotating speed (e.g., a normal speed to a quadruple speed), the power adjustment region PI is utilized. In contrast, in the case where the optical disk 100 is utilized at a high rotating speed (e.g., six-times as high as the normal speed, or faster), the power adjustment region PO is utilized. In the case of high-speed rotation, it may be difficult to ensure a predetermined rotating speed at the inner periphery; it is effective to utilize the power adjustment regions in the foregoing manner. In addition, the optimal value for the recording power is determined in accordance with the specification of the recording device.

The control of a series of the operation items described above is performed by an unillustrated system controller provided in the recording device 200. The program for controlling the system controller is stored in a program memory incorporated in the system controller.

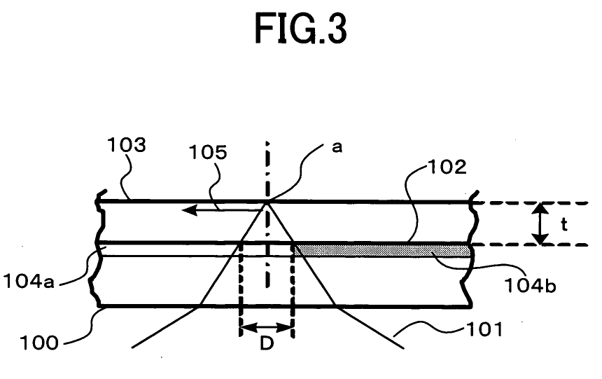

FIG. 3 is a diagram illustrating the relationship between recording layers and a light beam. In FIG. 3, Reference Numeral 100 denotes an optical disk. Reference Numeral 101 denotes a light beam that enters the optical disk 100 on the occasion of both recording and reproduction. Reference Numeral 102 denotes a first recording layer (film). Reference Numeral 103 denotes a second recording layer (film). Reference Characters 104a and 104b indicate the difference in the state of recording in the first recording film 102. In addition, the difference in the state of recording suggests, for example, the difference of whether or not data has been recorded in the recording film 102. In FIG. 3, Reference Character 104a indicates a data-unrecorded state. Reference Character 104b indicates a data-recorded state. Reference Character a indicates the recording start position for the second recording film 103. Reference Numeral 105 is an arrow indicating the region for recording that starts from the recording start position a and the direction of the recording. Reference Character t indicates the distance between the first recording film 102 and the second recording film 103. Reference Character D indicates the diameter of the light beam 101 that passes through the first recording film 102 in the case where data is recorded in the second recording film 103 (or in the case where data that has been recorded in the second recording film 103 is reproduced).

In the case where data is recorded in the second recording film 103, the first recording film 102 included in the diameter D of the light beam 101 is made to be in a data-unrecorded state. Otherwise, the state of recording in the second recording film 103 is adversely affected. Accordingly, it is required that a specific region, having a diameter of half the light beam diameter D, which is added to the portion, of the first recording film 102, that is situated inside the region 105 for recording that starts from the recording start position a is set, and the state of recording in the specific region is made to be the same as the state of recording in the first recording film 102.

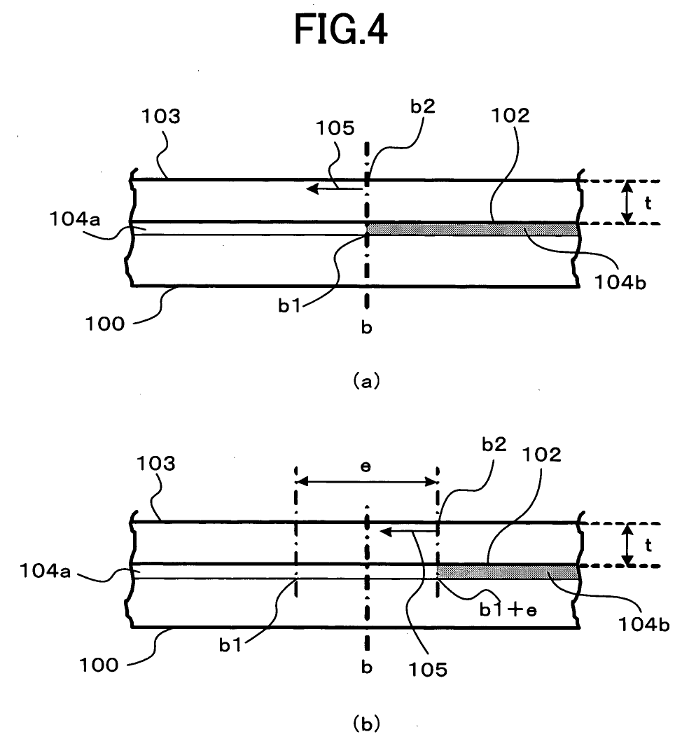

FIG. 4 is a diagram illustrating a positional deviation between a first layer and a second layer. FIG. 4(a) illustrates a case in which no positional deviation due to adhesion exists between a first layer and a second layer. FIG. 4(b) illustrates a case in which the positional deviation due to adhesion exists (in the case the deviation amount is maximal). In other words, the respective centers of the first layer and the second layer coincide with each other. In FIG. 4, Reference Numeral b denotes a position corresponding to an address in an ideal disk. Reference Character b1 denotes a position, corresponding to the position b, in the first recording layer 102. Reference Character b2 denotes a position, corresponding to the position b, in the second recording layer 103. Character e indicates a maximal decentering amount.

As illustrated in FIG. 4(a), in the case where no positional deviation exists between the first recording layer 102 and the second recording layer 103, the position b1 in the first recording layer 102 and the position b2 in the second recording layer 103 coincide with each other. In the case where, in the second recording film 103, data is recorded from the position b, in the direction indicated by an arrow 105, as illustrated in FIG. 4(a), it is required to make the state of recording in the first recording film 102 to be in a data-unrecorded state 104a, in accordance with where the position b1 is located.

As illustrated in FIG. 4(b), in the case where a positional deviation exists between the first recording layer 102 and the second recording layer 103, a positional-deviation amount e is caused between the position b1 in the first recording layer 102 and the position b2 in the second recording layer 103.

The positional deviation is caused due to the decentering, from the center position of the optical disk 100, of the first recording layer or the second recording layer. The maximal amount of the positional deviation between the first recording film 102 and the second recording film 103 is the maximal decentering amount e. In the case where, in the second recording layer 103 of the optical disk 100 in which a positional deviation has been caused due to the adhesion, data is recorded from the position b2, in the direction indicated by the arrow 105, as illustrated in FIG. 4(b), it is required to make the state of recording in the first recording layer 102 to be in a data-unrecorded state 104a, in consideration of the position b1 and the maximal decentering amount e.

Accordingly, in the case where data is recorded in the second recording layer 103, it is required to make a region, of the first recording layer 102, that corresponds to the recording position of the second recording layer 103 to be in a data-unrecorded state, in consideration of the effect, of the light beam 101, explained with reference to FIG. 3 and a positional deviation, as illustrated in FIG. 4(b), due to adhesion.

Letting a limitation region (A) denote a region having the foregoing allowance, a width Aw of the limitation region (A) is determined by half of the diameter D of the light beam 101 and the decentering amount e based on the maximal amount of the positional deviation due to adhesion. Specifically, the width Aw of the limitation region (A) is given by the following equation:

Aw=e+D/2

In this situation, assuming that, for example, the NA of the objective lens of an optical pickup is 0.6, and the maximal distance between the first recording layer 102 and the second recording layer 103 is 65 μm (55±15 μm), the diameter D of the light beam 101 is 56 μm. Additionally, assuming that the maximal decentering amount e is 40 μm, the width Aw of the limitation region (A) is 68 μm.

In Embodiment 1, when the power adjustment is performed, the limitation region (A) is taken into consideration; the width Aw of the limitation region (A) is set to e+D/2 or larger. As a result, the state of recording in the first layer is prevented from affecting the recording in the second layer.

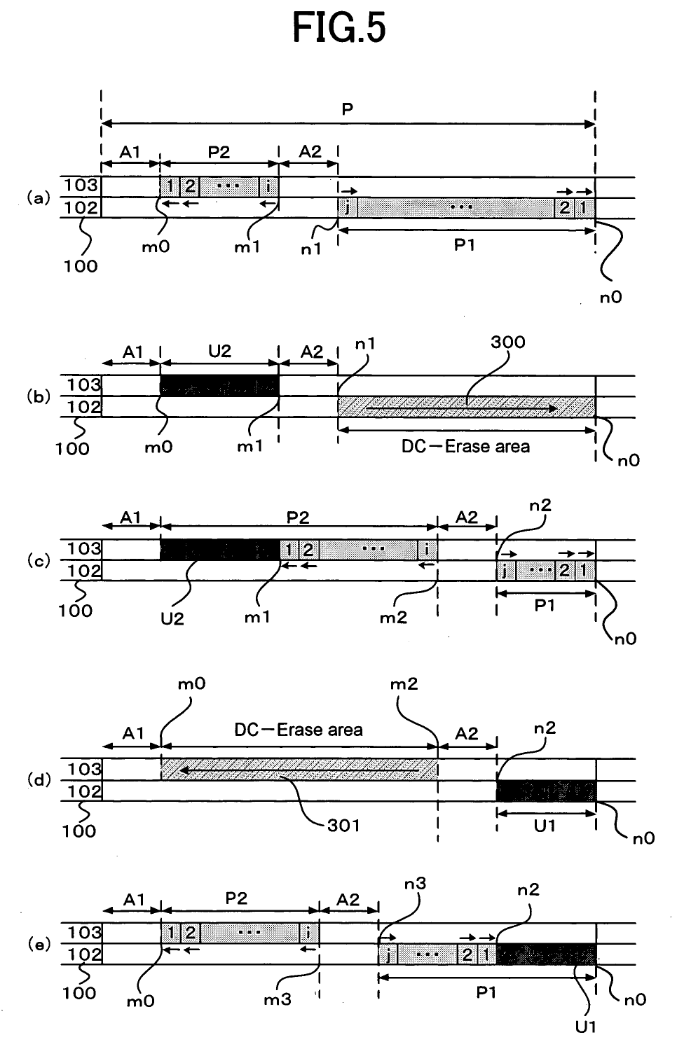

FIG. 5 is a set of diagrams illustrating a detailed configuration example of a power adjustment region (P) in an optical disk according to Embodiment 1 of the present invention and a usage method for the power adjustment region (P). FIG. 5(a) is a diagram illustrating a configuration example of the power adjustment region (P) and a usage method for the power adjustment region (P), in the case where the optical disk 100 has not been utilized. FIGS. 5(b) and 5(c) are each a diagram illustrating a usage method for the power adjustment region (P) in the case where a power adjustment region (P1) for the first layer that has been utilized is larger than a power adjustment region (P2) for the second layer. FIGS. 5(d) and 5(e) are each a diagram illustrating a usage method for the power adjustment region (P) in the case where the power adjustment region (P1) for the first layer that has been utilized is smaller than the power adjustment region (P2) for the second layer. In addition, the optical disk 100 includes the inner-periphery power adjustment region (PI) 110 and the outer-periphery power adjustment region (PO) 115; either one of both the power adjustment regions can be utilized in the same manner.

In FIG. 5, Reference Numeral 100 denotes an optical disk. Reference Numeral 102 denotes a first recording layer. Reference Numeral 103 denotes a second recording layer. In addition, in the following explanation, the power adjustment region for the first layer is referred to also as a first power adjustment region, and the power adjustment region for the second layer is referred to also as a second power adjustment region.

In the case where the optical disk 100 has not been utilized, as illustrated in FIG. 5(a), the power adjustment in the power adjustment region (P1) for the first layer is performed in order of the 1st (first) area, the 2nd (second) area, to the jth area, that are located from the position n0 to the position n1, i.e., from the outer periphery to the inner periphery of the optical disk 100. For example, in the 1st area of the power adjustment region (P1) for the first layer, as indicated by the arrows in FIG. 5(a), test recording is performed from the inner periphery to the outer periphery. Additionally, in order to manage the region that has been utilized for the power adjustment, the address information and the like of the utilized region is recorded in the recording management region (R) 111 (in FIG. 1) in the optical disk 100. The resultant value of the power adjustment is also recorded in the recording management region (R) 111.

In addition, with reference to FIG. 5, a case in which the limitation region (A1) is provided in the second recording layer 103 has been described. However, in the case where a data-unrecorded region having the same width as that of the limitation region (A1) can be ensured at the inner periphery, of the first recording layer 102, that is included in the power adjustment region P, it is not required to provide the limitation region (A1) in the second recording layer 103. Accordingly, in this case, the power adjustment can be performed by use of the innermost region, of the second recording layer 103, that is included in the power adjustment region P.

In the case where the optical disk 100 has not been utilized, as illustrated in FIG. 5(a), the limitation region (A1) is ensured at the position that is more inner than the power adjustment region (P2) for the second layer. Additionally, the power adjustment is performed in order of the 1st (first) area, the 2nd (second) area, to the ith area, that are located from the position m0 to the position m1, in the power adjustment region (P2) for the second layer. For example, in the 1st area of the power adjustment region (P2) for the second layer, as indicated by the arrows in FIG. 5(a), test recording is performed from the outer periphery to the inner periphery. Additionally, in order to manage the region that has been utilized for the power adjustment, the address information and the like of the region utilized for the test recording is recorded in the recording management region (R) 111 (in FIG. 1) in the optical disk 100. The resultant value of the power adjustment is also recorded in the recording management region (R) 111 (in FIG. 1).

The power adjustment in each recording layer can be performed, as far as the radial distance between a position n1 where the latest test recording in the first layer has been ended and a position m1 where the latest test recording in the second layer has been ended is longer than the width Aw of the limitation region (A2). Accordingly, the position of the limitation region (A2) varies depending on the number of the first-layer power adjustments and the number of the second-layer power adjustments.

Whether or not the radial distance between the position n1 and the position m1 has become the same as or shorter than the width Aw of the limitation region (A2) can be determined based on the address information recorded in the recording management region (R) 111 (in FIG. 1).

Next, in the case the radial distance between the positions n1 and m1 has become shorter than the width Aw of the limitation region (A2) and the power adjustment region (P1) that has been utilized for the first layer is larger than the power adjustment region (P2) that has been utilized for the second layer, the region from the position n1 to the position n0 is DC-erased, as illustrated in FIG. 5(b). In consequence, the state of the foregoing region becomes the same as the data-unrecorded state. In addition, in the explanation below, DC-erase is referred to also as Erase processing.

Furthermore, the address of the outermost region, which has been DC-erased, is recorded in the recording management region (R) 111 (in FIG. 1) in the optical disk 100. Additionally, that address is recorded in the region where the address information for the power adjustment region that has been utilized for the first layer is recorded. In addition, a region where the address of the DC-erased first-layer region is recorded may separately be provided in the recording management region (R) 111 in the optical disk 100.

After the first layer has been DC-erased, the power adjustment (test recording) in the first layer is performed in order of the position n0, 1, 2, to j, as illustrated in FIG. 5(c). Additionally, the power adjustment (test recording) in the second layer is performed in order of the position m1, which is situated at the outer periphery of the utilized power adjustment region (U2) (hereinafter, referred to also as the second utilized region U2), 1, 2, to i. Additionally, in order to manage the region that has been utilized for the power adjustment, the address information for the utilized region is recorded in the recording management region (R) 111 in the optical disk 100.

The power adjustment in each recording layer can be performed, as far as the radial distance between the position n2 where the latest test recording in the first layer has been ended and the position m2 where the latest test recording in the second layer has been ended is longer than the width Aw of the limitation region (A2).

In the case the radial distance between the positions n2 and m2 has become shorter than the width Aw of the limitation region (A2) and the power adjustment region (P1) that has been utilized for the first layer is shorter than the power adjustment region (P2) that has been utilized for the second layer, the region, from the position m2 to the position m0, that has been utilized for the power adjustment in the second layer is DC-erased, as illustrated in FIG. 5(d). In consequence, the state of the foregoing region becomes the same as the data-unrecorded state. Furthermore, the address of the innermost region, which has been DC-erased, is recorded in the recording management region (R) 111 (in FIG. 1) in the optical disk 100. Additionally, that address is recorded in the region where the address information for the power adjustment region that has been utilized for the second layer is recorded. In addition, a region where the address of the DC-erased second-layer region is recorded may separately be provided in the recording management region (R) 111 in the optical disk 100.

After the second layer has been DC-erased, the power adjustment (test recording) in the first layer is performed in order of the position n2, which is situated at the outer periphery of the utilized power adjustment region (U1) (hereinafter, referred to also as the first utilized region U1), 1, 2, to j, as illustrated in FIG. 5(e). Additionally, the power adjustment in the second layer is performed in order of the position m0, 1, 2, to i. Additionally, in order to manage the region that has been utilized for the power adjustment, the address information for the utilized region is recorded in the recording management region (R) 111 in the optical disk 100.

The power adjustment in each recording layer can be performed, as far as the radial distance between the position n3 where the latest test recording in the first layer has been ended and the position m3 where the latest test recording in the second layer has been ended is longer than the width Aw of the limitation region (A2).

After that, as is the case with the method described with reference to FIGS. 5(b) to 5(e), the utilized power adjustment region of the one, of the first and the second recording layer, in which more power adjustment regions are utilized than in the other is DC-erased. Meanwhile, in the recording layer that has not been DC-erased, unutilized power adjustment regions are utilized from a power adjustment region, among them, that follows utilized power adjustment regions.

Additionally, in the case where the respective numbers of utilized power adjustment regions in the first layer and the second layer are the same, the recording layer, in which data is supposed to be recorded next time, is DC-erased. As a result, the position immediately after the DC-erased region coincides with the position from which the next power adjustment is started. Therefore, the time required for seeking can drastically be reduced.

As described heretofore, according to Embodiment 1, the position of the limitation region (A2) varies depending on the respective lo numbers of power adjustments in the recording layers, therefore, the power adjustment region (P) can more widely be utilized, compared with a case in which the limitation region (A2) is fixed at a specific position. Moreover, because the repeated test recording is reduced in number, damage to the optical disk 100 can be suppressed.

Still moreover, the one, of the recording layers, that has a larger utilized power adjustment region than the other is DC-erased; a more number of power adjustments can be ensured after the DC-erasure. Accordingly, the occurrence frequency of the DC-erasure can be suppressed low. Therefore, the extra time required for the DC-erasure before the start of recording can be reduced.

Moreover, in the optical disk 100 according to Embodiment 1, the position of the limitation region (A2) is not fixed, but can be varied in accordance with the usage status. Accordingly, a wide test recording region can be ensured for each recording layer. Still moreover, the frequency of recurrent utilization of the test recording regions can be suppressed. Still moreover, the occurrence frequency of erasing processing, which is implemented when the test recording region is maximally utilized, can also be suppressed. Accordingly, damage to the optical disk 100 can be reduced. In other words, the speed of deterioration in the optical disk 100 can be reduced.

Furthermore, the occurrence frequency of erasing-processing operation, which takes an extra time, can be suppressed low, and the time required before the start of recording can be reduced throughout the utilization period of the optical disk 100.

### Embodiment 2

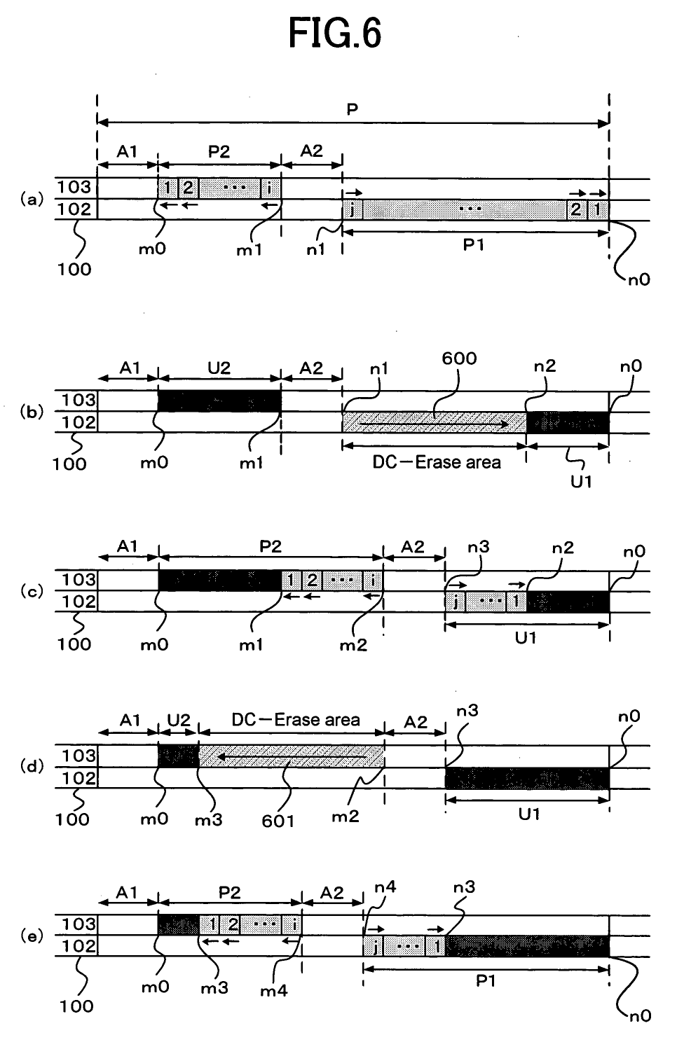

FIG. 6 is a set of explanatory diagrams for explaining recording power adjustment according to Embodiment 2. The configuration of a recording device in Embodiment 2 is the same as that of the recording device 200 explained in Embodiment 1. Accordingly, the explanation for the recording device will be omitted. Additionally, in the explanation below, configurations that have been explained in Embodiment 1 are designated by the same reference characters. Additionally, the explanations for the configurations will be omitted.

After predetermined data (video data, audio data, or the like) has been recorded in the data region 113 of an unutilized optical disk 100, a power adjustment region P is configured, as illustrated in FIG. 6(a).

In the case where, in the state illustrated in FIG. 6(a), data is recorded in the first recording layer 102, the recording power is adjusted, utilizing a region situated at the inner periphery of the first power adjustment region P1 (a region, at the inner periphery, adjacent to a region j). In contrast, in the case where, in the state illustrated in FIG. 6(a), data is recorded in the second recording layer 103, the recording power is adjusted, utilizing a region situated at the outer periphery of the second power adjustment region P2 (a region, at the outer periphery, adjacent to a region i).

However, in the state illustrated in FIG. 6(a), the radial distance (region) between the position n1 in the first layer 102 and the position m1 in the second layer 103 is the same as the limitation region A2. Thus, the recording order cannot be satisfied. Accordingly, also in Embodiment 2, the first power adjustment region P1, which has a larger utilized region, receives erasing processing (in FIG. 6(b)), as is the case with Embodiment 1.

In this regard, however, in Embodiment 2, the erasing processing is not applied throughout the first utilized region U1. The erasing processing is applied only to a predetermined region in the first utilized region U1.

In addition, the predetermined region can arbitrarily be set in a device (recording device) utilizing a recording method according to Embodiment 2. However, the predetermined region is provided at least in such a way that, even after the power adjustment, following the erasing processing, has been performed in the first power adjustment region P1 or in the second power adjustment region P2, the recording order is satisfied (i.e., in such way that the limitation region A2 can be ensured).

As described above, after the erasing processing has been applied to the first utilized region U1, the power adjustment is performed utilizing the first power adjustment region P1 or the second power adjustment region P2, in the same manner as that explained in Embodiment 1 (in FIG. 6(c)).

Next, it is assumed that, in the state illustrated in FIG. 6(c), the second power adjustment region P2 has been utilized for the power adjustment, up to the region i, and the first power adjustment region P1 has been utilized for the power adjustment, up to the region j. In this situation, in the case where the power adjustment is performed in the power adjustment region P, the recording order cannot be satisfied. In other words, the limitation region A2, which should be ensured along the radial direction of the optical disk 100 and between the first power adjustment region P1 and the second power adjustment region P2, cannot be ensured.

Thus, the erasing processing is applied to the second utilized region U2, which has a larger utilized region (in FIG. 6(d)). In addition, also in the case of FIG. 6(d), the erasing processing is applied only to a predetermined region in the second utilized region U2, as is the case with FIG. 6(b).

As described above, after the erasing processing has been applied to the second utilized region U2, the power adjustment is performed utilizing the first power adjustment region P1 or the second power adjustment region P2, in the same manner as that explained in Embodiment 1 (in FIG. 6(e)).

As described heretofore, with the recording device in Embodiment 2, in the case where the erasing processing is applied to the first utilized region U1 or the second utilized region U2, it is applied only to the predetermined region in the first utilized region U1 or the second utilized region U2.

Thus, the time required for the erasing processing can be reduced, compared with a case in which the erasing processing is applied throughout the first utilized region U1 or throughout the second utilized region U2. Therefore, the time required before the start of data recording can be reduced.

### Embodiment 3

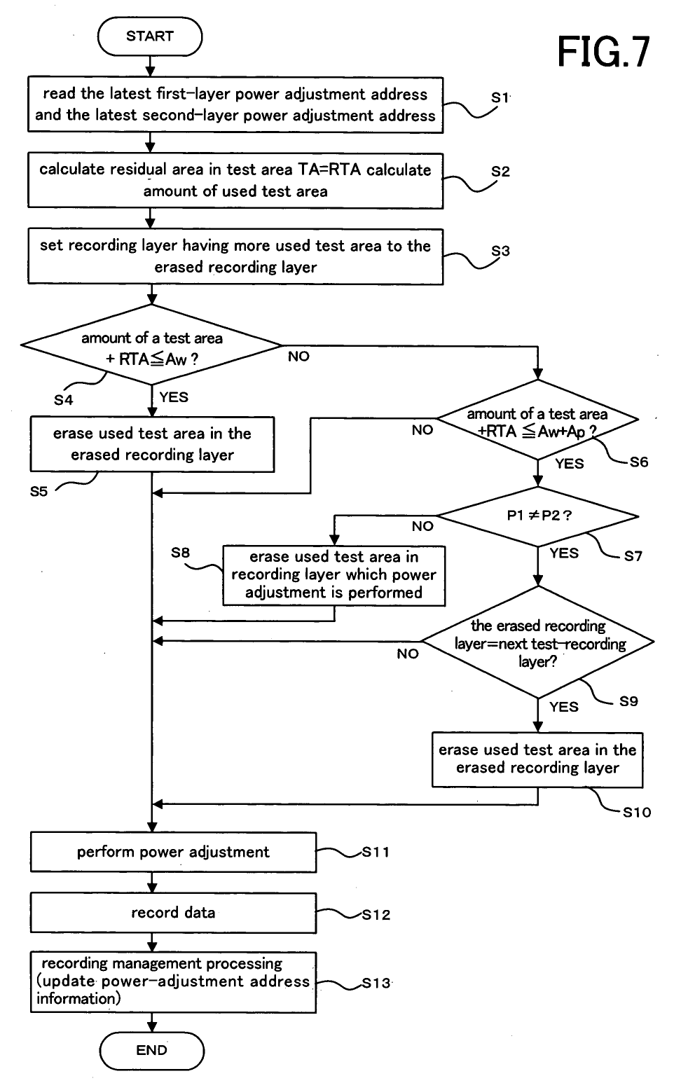

FIG. 7 is a flowchart for explaining recording power adjustment in a recording device according to Embodiment 3. The configuration of a recording device in Embodiment 3 is the same as that of the recording device 200 explained in Embodiment 1. Accordingly, the explanation for the configuration will be omitted. Additionally, in the explanation below, configurations that have been explained in Embodiment 1 are designated by the same reference characters. Additionally, the explanations for the configurations will be omitted.

In Embodiment 3, the region consisting of the Aw described above and a marginal region Ap is termed a limitation region A2 (Aw′). Here, the marginal region Ap denotes a region having a size corresponding to that of a plurality of regions (e.g., respective regions indicated by 1, 2, to i, in FIG. 5(a); hereinafter, referred to also as a one-time test region) that are each utilized for power adjustment in the power adjustment region. Accordingly, the limitation region A2 is given by Equation (1) below. In addition, the size of the marginal region Ap can arbitrarily be set; however, it is desirable that the size is as large as that of several to several dozen regions that are each utilized for power adjustment.

Aw′=Aw+Ap=e+D/2+Ap (1)

The operation of the recording device according to Embodiment 3 will be explained below with reference to FIG. 7. The system controller (unillustrated) in the recording device obtains the latest address (e.g., the address corresponding to the position n1 in FIG. 5(a); hereinafter, referred to also as a latest first-layer power adjustment address) in the first power adjustment region and the latest address (e.g., the address corresponding to the position m1 in FIG. 5(a); hereinafter, referred to also as a latest second-layer power adjustment address) in the second power adjustment region that have been recorded in the recording management region R 111 (the step S1).

After receiving the addresses, the system controller calculates the size of a region (hereinafter, referred to also as a residual region RTA) formed, along the radial direction of the optical disk, between the latest first-layer power adjustment address and the latest second-layer power adjustment address (the step S2). Additionally, based on the addressed, the system controller calculates the sizes of the utilized test regions P1 and P2 in the recording layers 102 and 103, respectively (the step S2). After the calculation, the system controller sets the test region having a larger capacity, as a recording layer in which erasing processing is preferentially performed (the step S3). In addition, in the explanation below, the recording layer, which has been set as a recording layer in which erasing processing is preferentially performed, is referred to also as an erasing recording layer. Additionally, in the step S3, in the case where the respective capacities of the first test region P1 and the second test region P2 are the same, either one of the test regions is set as the erasing recording layer.

When starting the recording of data in the data region D 113, the system controller in the recording device determines whether or not the capacity consisting of the respective capacities of the residual region RTA and the one-time test region is the same or smaller than that of the limitation region Aw (the step S4).

When, in the foregoing determination in the step S4, the capacity consisting of the respective capacities of the residual region RTA and the one-time test region is the same or smaller than that of the limitation region Aw (S4: YES), the system controller controls the servo circuit 208 and the like so as to apply the erasing processing to the erasing recording layer (the step S5). Then, the system controller performs the power adjustment in the recording layer in which the data is recorded (the step S11). The data is recorded in the data region D, with a light beam having the resultant intensity of the power adjustment (the step S12). After the data recording has been completed, the system controller updates the respective latest addresses, of the power adjustment regions, recorded in the recording management region to the latest addresses, of the power adjustment regions, which are allocated after the power adjustments (the step S13). When the update has been completed, the system controller ends the processing (END).

In contrast, when, in the foregoing determination in the step S4, the capacity consisting of the respective capacities of the residual region RTA and the one-time test region is larger than that of the limitation region Aw (S4: NO), the system controller determines whether or not the capacity consisting of the respective capacities of the residual region RTA and the one-time test region is the same or smaller than Aw′ (the step S6).

When, in the foregoing determination in the step S6, the capacity consisting of the respective capacities of the residual region RTA and the one-time test region is larger than Aw′ (S6: NO), the recording device performs the processing items in S11 to S13 (the step S5). When the processing in S13 has been completed, the system controller ends the processing (END).

In contrast, when, in the foregoing determination in the step S6, the capacity consisting of the respective capacities of the residual region RTA and the one-time test region is the same or smaller than Aw′ (S6: YES), the system controller determines whether or not the respective sizes of the first test region P1 and the second test region P2 are the same (the step S7).

When, in the foregoing determination in the step S7, the respective sizes of the first test region P1 and the second test region P2 are the same (S7: NO), the system controller controls the servo circuit 208 and the like so as to apply the erasing processing to the utilized regions U1 and U2 of the recording layers to which the power adjustment is applied (the step S8). After the erasing processing has been completed, the recording device 200 performs the processing items in S11 to S13. When the processing in S13 has been completed, the system controller ends the processing (END).

In contrast, When, in the foregoing determination in the step S7, the respective sizes of the first test region P1 and the second test region P2 are not the same (S7: YES), the system controller determines whether or not the erasing recording layer and the recording layer in which data is to be recorded are the same (the step S9).

When, in the foregoing determination in the step S9, the erasing recording layer and the recording layer in which data is to be recorded are not the same, the recording device performs the processing items in S11 to S13. When the processing in S13 has been completed, the system controller ends the processing (END).

In contrast, when, in the foregoing determination in the step S9, the erasing recording layer and the recording layer in which data is to be recorded are the same, the system controller controls the servo circuit 208 and the like so as to apply the erasing processing to the utilized regions U1 and U2 of the erasing recording layers. After the erasing processing has been completed, the recording device 200 performs the processing items in S11 to S13. When the processing in S13 has been completed, the system controller ends the processing (END).

The operation explained above will be described in a more simplified manner as follows:

(1) In the case where the residual region RTA is represented by RTA≦Aw+Ap, the relation between the capacities of the test regions P1 and P2 is represented by P1>P2, and the recording layer in which the power adjustment is to be performed is the first recording layer 102, the erasing processing is applied to the first test region P1 and then the power adjustment is performed in the first recording layer 102.

(2) In the case where the residual region RTA is represented by RTA≦Aw+Ap, the relation between the capacities of the test regions P1 and P2 is represented by P1>P2, and the recording layer in which the power adjustment is to be performed is the second recording layer 103, the power adjustment is performed in the second recording layer, without applying the erasing processing to the first test region P1.

(3) In the case where the residual region RTA is represented by RTA≦Aw, the relation between the capacities of the test regions P1 and P2 is represented by P1>P2, and the recording layer in which the power adjustment is to be performed is the second recording layer 103, the erasing processing is applied to the first test region P1 and then the power adjustment is performed in the second recording layer.

(4) In the case where the residual region RTA is represented by RTA≦Aw+Ap, the relation between the capacities of the test regions P1 and P2 is represented by P1<P2, and the recording layer in which the power adjustment is to be performed is the first recording layer 102, the power adjustment is performed in the first recording layer 102, without applying the erasing processing to the first test region P1.

(5) In the case where the residual region RTA is represented by RTA≦Aw+Ap, the relation between the capacities of the test regions P1 and P2 is represented by P1<P2, and the recording layer in which the power adjustment is to be performed is the second recording layer 103, the erasing processing is applied to the second test region P2 and then the power adjustment is performed in the second recording layer.

(6) In the case where the residual region RTA is represented by RTA≦Aw, the relation between the capacities of the test regions P1 and P2 is represented by P1<P2, and the recording layer in which the power adjustment is to be performed is the first recording layer 102, the erasing processing is applied to the second test region P2 and then the power adjustment is performed in the first recording layer.

As described heretofore, in the recording device according to Embodiment 3, a new limitation region, which is obtained by adding the marginal region Ap to a critical mass of limitation region, is set as the recording order. Accordingly, with the recording device according to Embodiment 3, preferential erasing adjustment can be performed in the case where the recording layer having more utilized regions coincides with the recording layer in which the power adjustment is to be performed next. In other words, the frequency of performing the erasing adjustment becomes high as a whole, in the case where the recording layer having more utilized regions coincides with the recording layer in which the power adjustment is to be performed next. In consequence, the case occurs frequently, in which the optical head 205 that has carried out the erasing processing is situated in the vicinity of a region that is utilized when the power adjustment is performed in each recording layer. Therefore, the time (seek time) that the optical head 205, which has carried out the erasing processing, takes to move a region that is utilized when the power adjustment is performed can be reduced.

In addition, the processing items from S1 to S3 in FIG. 7 may be carried out at arbitrary time instants. For example, the foregoing processing items may be carried out in the following way:

In the first place, when the optical disk 100 is inserted into the recording device 200, the system controller determines whether the optical disk 100 is a data-recorded optical disk or a data-unrecorded optical disk. In the second place, the processing items S1 to S3 are carried out in the case where the optical disk 100 is a data-recorded optical disk.

In addition, depending on the specification of a recording device, a case may occurs in which the latest power adjustment address corresponding to each recording layer is not recorded in the recording management region in the optical disk. In such a case as this, the latest power adjustment address, corresponding to each recording layer, in the test region P may be detected in the recording device. Specifically, based on a signal, corresponding to the amount of a light beam reflected by the optical disk 100, which is outputted from the optical head 205, the system controller performs the detection.

### Embodiment 4

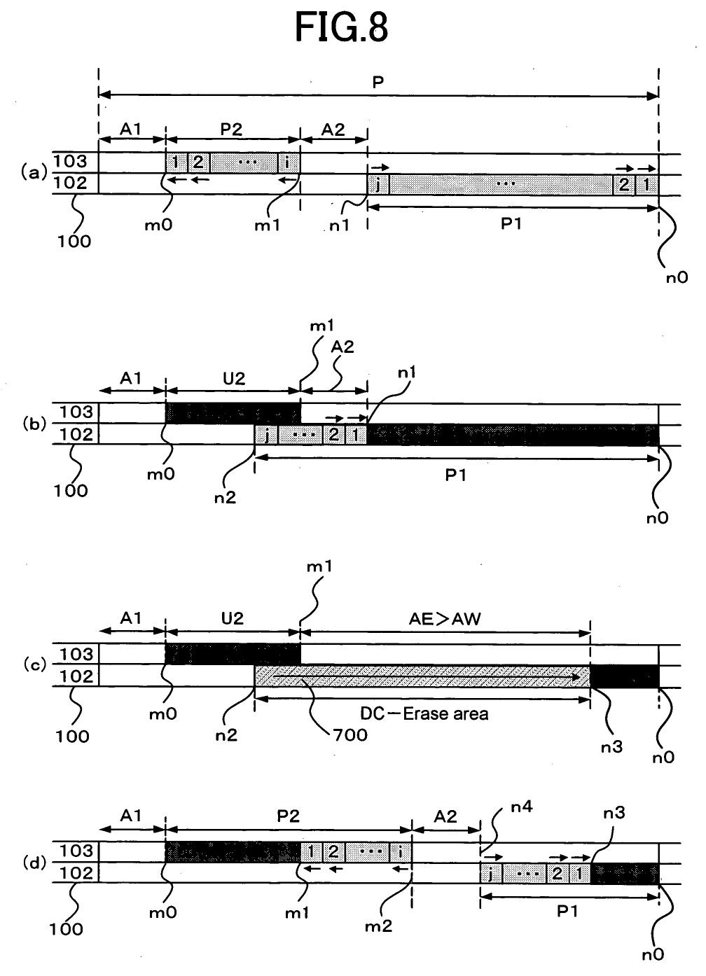

FIG. 8 is a set of explanatory diagrams for explaining recording method according to Embodiment 4. The configuration of a recording device in Embodiment 4 is the same as that of the recording device 200 explained in Embodiment 1. Accordingly, the explanation for the configuration will be omitted. Additionally, in the explanation below, configurations that have been explained in Embodiments 1 and 3 are designated by the same reference characters. Accordingly, the explanations for the configurations will be omitted.

It is assumed that, after predetermined data (video data, audio data, or the like) has been recorded in the data region 113 of an unutilized optical disk 100, a power adjustment region P is configured, as illustrated in FIG. 8(a).

In the case where, in the state illustrated in FIG. 8(a), data is recorded in the first recording layer 102, the recording power is adjusted, utilizing a region situated at the inner periphery of the first power adjustment region P1 (a region, at the inner periphery, adjacent to a region j). In contrast, in the case where, in the state illustrated in FIG. 8(a), data is recorded in the second recording layer 103, the recording power is adjusted, utilizing a region situated at the outer periphery of the second power adjustment region P2 (a region, at the outer periphery, adjacent to a region i).

However, in the state illustrated in FIG. 8(a), the radial distance (region) between the position n1 in the first layer 102 and the position m1 in the second layer 103 is the same as the limitation region A2. Thus, the recording order cannot be satisfied.

Thus, in Embodiment 4, in the case where the recording order cannot be satisfied, the following processing is performed.

In the state illustrated in FIG. 8(a), in the case where the power adjustment is performed in the first recording layer 102, no erasing processing is carried out. In stead, the power adjustment is performed in a region adjacent to the inner-periphery side of the region j indicated in FIG. 8(a). In other words, in the case where the power adjustment is performed in the first recording layer 102 in the power adjustment region P, even though the limitation region A2 cannot be ensured, the power adjustment is carried on in the first recording layer 102 in the power adjustment region P (in FIG. 8(b)).

In the case where, after the region, in the first recording layer 102, up to the region j in FIG. 8(b) has been utilized for the power adjustment, the power adjustment is performed in the second recording region 103, the recording device 200 performs processing items in the following manner. In the case where, after the region, in the first recording layer 102, up to the region j in FIG. 8(b) has been utilized for the power adjustment, the region from the position n0 to the position n2 in FIG. 8(b) is the first recorded region. Thus, the recording device 200 applies erasing processing to a predetermined region in the first recorded region (in FIG. 8(c)). In addition, the predetermined region is set in the same manner as that explained in Embodiment 2; however, in FIG. 8(c), a case has been illustrated in which the power adjustment is applied to the region from the position n2 to the position n3 in the first recording layer.

After the erasing processing has been performed, the power adjustment is carried out in the power adjustment region P in the same manner as that explained in Embodiment 2 (in FIG. 8(d)).

In addition, in FIG. 8(b), the overall region from the position n2 to the position n0 in the first recording layer 102, which is the utilized region (the first utilized region), becomes acceptably homogeneous. Thus, in the state illustrated in FIG. 8(b), a given region in the second recording layer 103 may be utilized as the power adjustment region.

However, the first utilized region is a region that has been utilized for the power adjustment; therefore, a high-intensity light beam is irradiated onto part of the first utilized region. In contrast, a low-intensity light beam is irradiated onto the other region. That is to say, the first utilized region is not completely homogeneous. Accordingly, in the case where, in the second recording layer 103, the power adjustment is performed with a light beam that has passed through the first utilized region, the optimal intensity of a light beam cannot stably be obtained. Therefore, as explained in Embodiment 4, it is desirable to perform the erasing processing also in the state illustrated in FIG. 8(b).

As described above, in the recording device according to Embodiment 4, even when the recording order is not satisfied, no erasing processing is performed in the case where the first recording layer 102 is continuously utilized.

Accordingly, the number of the erasing processing instances in the first recording layer 103 can be suppressed to a critical mass. Therefore, the deterioration in the optical disk 100 is prevented, thereby enabling the optical disk 100 to be utilized for a long time.

In addition, in Embodiment 4, a case, in which the erasing processing is applied to a predetermined region, has been explained; however, the erasing processing may be applied to the overall first utilized region in the same manner as that explained in Embodiment 1.

Additionally, in the foregoing explanation, a case, in which data is recorded in the optical disk 100, has mainly been discussed; meanwhile, the reproduction of the optical disk is performed, e.g., in the following manner. That is to say, in a reproduction device, by controlling the servo system of the reproduction device, based on the reproduction control information, data recorded in the optical disk 100 is read and reproduced.

What is claimed is:

1. A recording method for recording data in an optical disk which includes a plurality of recording layers each having a power adjustment region for performing adjustment of power of a light beam emitted while the data is recorded and in which the data can be rewritten in each recording layer,
wherein, in performing the adjustment of power,
when, along a radial direction of the optical disk, a region between a first power adjustment region that is a power adjustment region in a first recording layer and a second power adjustment region that is a power adjustment region in a second recording layer provided at a position that is more apart than that of the first recording layer from a plane from which the light beam enters becomes smaller than a size of a limitation region,
erasing processing is performed in which the utilized region, out of two respective utilized regions in the first and second power adjustment regions, which is larger is erased.

2. A recording method for recording data in an optical disk which includes a plurality of recording layers each having a power adjustment region for performing adjustment of power of a light beam emitted while the data is recorded and in which the data can be rewritten in each recording layer,
wherein, in performing the adjustment of power,
the power adjustment region, out of a first power adjustment region that is a power adjustment region in a first recording layer and a second power adjustment region that is a power adjustment region in a second recording layer provided at a position that is more apart than that of the first recording layer from a plane from which the light beam enters, whose utilized region is larger than that of the other power adjustment region is set as a power adjustment region in which erasing processing is applied to the utilized region, and
in the case where the capacity of a region between the first power adjustment region and the second power adjustment region is larger than the capacity of a limitation region and smaller than the sum of the capacity of the limitation region and the capacity of a marginal region, and a recording layer in which the data is recorded coincides with a recording layer having the power adjustment region that has been set as a power adjustment region in which the erasing processing is performed, erasing processing is applied to the set power adjustment region.

3. The recording method according to claim 1,
wherein, when the erasing processing of erasing the utilized region is performed, only part of the utilized region is erased.

4. The recording method according to claim 2,
wherein, when the erasing processing of erasing the utilized region is performed, only part of the utilized region is erased.

5. The recording method according to claim 1,
wherein, the size of a limitation region Aw is set to satisfy the following relation,
Aw≧e+D/2,
wherein, e is the decentering amount based on the maximal amount of the positional deviation due to adhesion between the first recording layer and the second recording layer, and D is the diameter of the light beam that passes through the first recording layer in the case where the data is recorded in the second recording layer.

6. The recording method according to claim 2,
wherein, the size of a limitation region Aw is set to satisfy the following relation,
Aw≧e+D/2,
wherein, e is the decentering amount based on the maximal amount of the positional deviation due to adhesion between the first recording layer and the second recording layer, and D is the diameter of the light beam that passes through the first recording layer in the case where the data is recorded in the second recording layer.

7. The recording method according to claim 2,
wherein, the size of the marginal region is as large as the summed size of a plurality of regions each of which is utilized in a one-time power adjustment.

8. The recording method according to claim 1, further comprising:
the step of recording respective latest addresses of the power adjustment regions in a predetermined region in the optical disk, after the power adjustment has been performed.

9. The recording method according to claim 2, further comprising:
the step of recording respective latest addresses of the power adjustment regions in a predetermined region in the optical disk, after the power adjustment has been performed.

10. An optical disk in which data is recorded in accordance with the recording method according to claim 1, the method comprising:
a predetermined region in which latest addresses are recorded; and
a reproduction information region in which information necessary for reproducing the data that has been recorded in the optical disk is recorded.

11. An optical disk in which data is recorded in accordance with the recording method according to claim 2, the method comprising:
a predetermined region in which latest addresses are recorded; and
a reproduction information region in which information necessary for reproducing the data that has been recorded in the optical disk is recorded.

12. The optical disk according to claim 10,
wherein the configuration is in such a way that a radial position of the region between the first power adjustment region and the second power adjustment region is variable.

13. The optical disk according to claim 11,
wherein the configuration is in such a way that a radial position of the region between the first power adjustment region and the second power adjustment region is variable.

14. A reproduction method for reproducing data recorded in the optical disk according to claim 12,
wherein, based on the information recorded in the reproduction information region, the data that has been recorded in the optical disk is reproduced.

15. A reproduction method for reproducing data recorded in the optical disk according to claim 13,
wherein, based on the information recorded in the reproduction information region, the data that has been recorded in the optical disk is reproduced.

16. An optical disk which includes a plurality of recording layers in each of which a power adjustment region, for performing adjustment of power of a beam emitted while the data is recorded, is set and in which the data can be rewritten in each recording layer, the optical disk comprising:
a limitation region between a first power adjustment region that is a power adjustment region in a first recording layer and a second power adjustment region that is a power adjustment region in a second recording layer provided at a position that is more apart than that of the first recording layer from a plane from which the beam enters;
an address information recording region in which information items corresponding to respective latest addresses of the power adjustment regions are recorded, after the power adjustment has been performed;
a reproduction information region in which information necessary for reproducing the data that has been recorded in the optical disk is recorded,
wherein, along a radial direction of the optical disk, the position of the limitation region is variable.

17. A recording/reproduction device for recording data in an optical disk which includes a plurality of recording layers each having a power adjustment region for performing adjustment of power of a beam emitted while the data is recorded and in which the data can be rewritten in each recording layer, the recording/reproduction device comprising:
a power adjustment unit for performing the adjustment of power; and
an erasing processing unit for performing erasing processing in which,
when, along a radial direction of the optical disk, a region between a first power adjustment region that is a power adjustment region in a first recording layer and a second power adjustment region that is a power adjustment region in a second recording layer provided at a position that is more apart than that of the first recording layer from a plane from which the beam enters becomes smaller than a size of a limitation region,
the utilized region, out of two respective utilized regions in the first power adjustment region and the second power adjustment region, which is larger is erased.

18. A recording/reproduction device for recording data in an optical disk which includes a plurality of recording layers each having a power adjustment region for performing adjustment of power of a beam emitted while the data is recorded and in which the data can be rewritten in each recording layer, the recording/reproduction device comprising:
a power adjustment unit for performing the adjustment of power;
a setting unit for setting the power adjustment region, out of a first power adjustment region that is a power adjustment region in a first recording layer and a second power adjustment region that is a power adjustment region in a second recording layer provided at a position that is more apart than that of the first recording layer from a plane from which the beam enters, whose utilized region is larger than that of the other power adjustment region, as a power adjustment region in which erasing processing is applied to the utilized region; and
an erasing processing unit for performing erasing processing in which, in the case where the capacity of a region between the first power adjustment region and the second power adjustment region is larger than the capacity of a limitation region and smaller than the sum of the capacity of the limitation region and the capacity of a marginal region, and a recording layer in which the data is recorded coincides with a recording layer having the power adjustment region that has been set as a power adjustment region in which the erasing processing is performed, erasing processing is applied to the set power adjustment region.

19. The recording/reproduction device according to claim 17,
wherein, when the erasing processing of erasing the utilized region is performed, only part of the utilized region is erased.

20. The recording/reproduction device according to claim 18,
wherein, when the erasing processing of erasing the utilized region is performed, only part of the utilized region is erased.

21. The recording/reproduction device according to claim 17,
wherein, the size of a limitation region Aw is set to satisfy the following relation,
Aw≧e+D/2,
wherein, e is the decentering amount based on the maximal amount of the positional deviation due to adhesion between the first recording layer and the second recording layer, and D is the diameter of the light beam that passes through the first recording layer in the case where the data is recorded in the second recording layer.

22. The recording/reproduction device according to claim 18,
wherein, the size of a limitation region Aw is set to satisfy the following relation,
Aw≧e+D/2,
wherein, e is the decentering amount based on the maximal amount of the positional deviation due to adhesion between the first recording layer and the second recording layer, and D is the diameter of the light beam that passes through the first recording layer in the case where the data is recorded in the second recording layer.

23. The recording/reproduction device according to claim 18,
wherein, the size of the marginal region is as large as the summed size of a plurality of regions each of which is utilized in a one-time power adjustment.

24. The recording/reproduction device according to claim 17, further comprising:
the step of recording respective latest addresses of the power adjustment regions in a predetermined region in the optical disk, after the power adjustment has been performed.

25. The recording/reproduction device according to claim 18, further comprising:
the step of recording respective latest addresses of the power adjustment regions in a predetermined region in the optical disk, after the power adjustment has been performed.
